(19) United States
(12) Patent Application Publication
(10) Pub. No.: US 2023/0368535 A1
(43) Pub. Date: Nov. 16, 2023

(54) PRODUCT IDENTIFICATION APPARATUS, PRODUCT IDENTIFICATION METHOD, AND NON-TRANSITORY COMPUTER-READABLE MEDIUM

(71) Applicant: NEC Corporation, Minato-ku, Tokyo (JP)

(72) Inventors: Yaeko YONEZAWA, Tokyo (JP); Katsumi KIKUCHI, Tokyo (JP); Soma SHIRAISHI, Tokyo (JP); Yu NABETO, Tokyo (JP)

(73) Assignee: NEC Corporation, Minato-ku, Tokyo (JP)

(21) Appl. No.: 17/923,288

(22) PCT Filed: May 14, 2022
(86) PCT No.: PCT/JP2020/019259

§ 371 Date: Nov. 4, 2022

(51) Int. Cl. G06V 20/50; G06T 7/73

(52) U.S. Cl. CPC G06V 20/50; G06T 7/73; G06T 2207/10144

(57) ABSTRACT

A product identification apparatus (20) includes an acquisition unit (210), and an image processing unit (220). The acquisition unit (210) acquires a plurality of images captured by an image capturing apparatus (10). These plurality of images are generated by capturing an image of a same product shelf (40) while changing a parameter. The image processing unit (220) determines a product (50) located on the product shelf (40) by processing these plurality of images, and outputs a result of the determination. The determination result is, for example, the one in which product identification information (e.g., a JAN code) of the product (50), and a position of the product (50) on the product shelf (40) are associated with each other.

### TECHNICAL FIELD

The present invention relates to a product identification apparatus, a product identification method, and a program.

### BACKGROUND ART

In a store where a product is sold, a position of a product on a product shelf, specifically, a shelf layout is important, since the shelf layout affects sales in the store. For example, Patent Document 1 describes that, by processing a captured image of a product shelf, a product region image included in the image is determined, and a product is determined for each product region image. In particular, Patent Document 1 describes that a plurality of images are generated by capturing an image of a product shelf at different angles a plurality of times, and identification information of a product is determined by using these plurality of images.

### RELATED DOCUMENT

### Patent Document

[Patent Document 1] Japanese Patent Application Publication No. 2019-160328

### SUMMARY OF THE INVENTION

### Technical Problem

It is often a case that a light source is disposed near a product display region where a product or a product sample is displayed, such as a product shelf or a vending machine. As for the vending machine, a light-transmissive cover member is disposed in front of the product display region of the vending machine, and external light may be reflected on the cover member. Therefore, a part of an image may be overexposed, or conversely, an image may become unclear due to underexposure, depending on an imaging condition. In a case where an image is in a state as described above, image analysis accuracy is lowered.

One example of an object of the present invention is to suppress lowering of image analysis accuracy, in a case where a product and/or a product sample is determined by analyzing a captured image of a product display region where the product and/or the product sample is displayed.

### Solution to Problem

The present invention provides a product identification apparatus including:
an acquisition unit that acquires a plurality of images obtained by capturing a product display region where a product and/or a product sample is arranged, the plurality of images having different imaging parameters of an image capturing unit from each other; and
an image processing unit that determines the product and/or the product sample located in the product display region by processing the plurality of images, and outputs a result of the determination.

The present invention provides a product identification apparatus including:
an acquisition unit that acquires analysis data being a result of processing a plurality of images obtained by capturing a product display region where a product and/or a product sample is arranged, and indicating a feature point of a product or a product sample and a position of the feature point, for each of the plurality of images; and
a data processing unit that determines the product or the product sample located in the product display region by processing the analysis data, and outputting a result of the determination, wherein
the plurality of images have different imaging parameters of an image capturing unit from each other.

The present invention provides a product identification method including,
by a computer:
acquiring a plurality of images obtained by capturing a product display region where a product and/or a product sample is arranged, the plurality of images having different imaging parameters of an image capturing unit from each other; and
determining the product or the product sample located in the product display region by processing the plurality of images, and outputting a result of the determination.

The present invention provides a product identification method including,
by a computer:
acquiring analysis data being a result of processing a plurality of images obtained by capturing a product display region where a product and/or a product sample is arranged, and indicating a feature point of a product or a product sample, and a position of the feature point, for each of the plurality of images; and
determining the product or the product sample located in the product display region by processing the analysis data, and outputting a result of the determination, wherein
the plurality of images have different imaging parameters of an image capturing unit from each other.

The present invention provides a program causing a computer to include:
an acquisition function of acquiring a plurality of images obtained by capturing a product display region where a product and/or a product sample is arranged, the plurality of images having different imaging parameters of an image capturing unit from each other; and
an image processing function of determining the product or the product sample located in the product display region by processing the plurality of images, and outputting a result of the determination.

The present invention provides a program causing a computer to include:
an acquisition function of acquiring analysis data being a result of processing a plurality of images obtained by capturing a product display region where a product and/or a product sample is arranged, and indicating a feature point of a product or a product sample and a position of the feature point, for each of the plurality of images; and
a data processing function of determining the product or the product sample located in the product display region by processing the analysis data, and outputting a result of the determination, wherein
the plurality of images have different imaging parameters of an image capturing unit from each other.

### Advantageous Effects of Invention

The present invention enables to suppress lowering of image analysis accuracy, in a case where a product and/or a product sample is determined by analyzing a captured image of a product display region where the product and/or the product sample is displayed.

### BRIEF DESCRIPTION OF THE DRAWINGS

The above-described object, the other objects, features, and advantages will become more apparent from suitable example embodiments described below and the following accompanying drawings.

FIG. 1 is a diagram illustrating a usage environment of a product identification apparatus according to an example embodiment.

FIG. 2 is diagram illustrating one example of a functional configuration of the product identification apparatus.

FIG. 3 is a diagram illustrating a hardware configuration example of the product identification apparatus.

FIG. 4 is a flowchart illustrating a first example of processing to be performed by the product identification apparatus.

FIG. 5 is a flowchart illustrating a first detailed example of step S20 in FIG. 4.

FIG. 6 is a flowchart illustrating a second detailed example of step S20 in FIG. 4.

FIG. 7 is a flowchart illustrating the second detailed example of step S20 in FIG. 4.

FIG. 8 is a flowchart illustrating a second example of processing to be performed by the product identification apparatus.

FIG. 9 is a flowchart illustrating processing to be performed by the product identification apparatus according to a first modification example.

### DESCRIPTION OF EMBODIMENTS

Hereinafter, an example embodiment according to the present invention is described with reference to the drawings. Note that, in all the drawings, a similar constituent element is indicated by a similar reference sign, and description thereof will not be repeated as appropriate.

### Example Embodiment

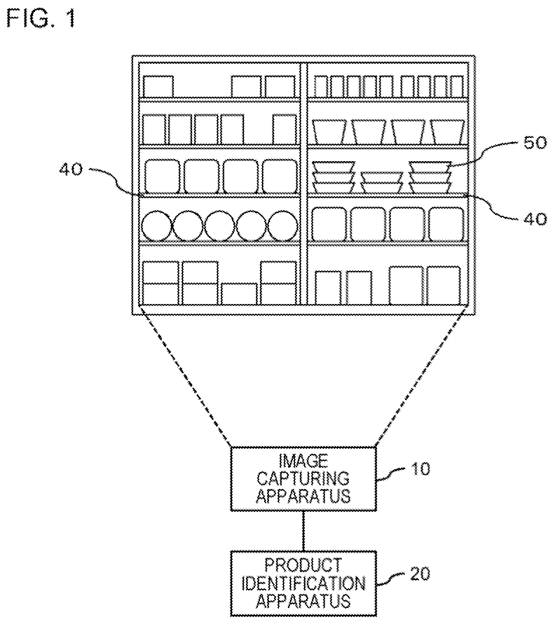

FIG. 1 is a diagram illustrating a usage environment of a product identification apparatus 20 according to a present example embodiment. The product identification apparatus 20 is used together with an image capturing apparatus 10. The image capturing apparatus 10 captures an image of a product placement region. The product placement region may be a product shelf 40 installed in a store, or may be a region where a product and/or a product sample is displayed in a vending machine.

An image generated by the image capturing apparatus 10 is transmitted to the product identification apparatus 20. The product identification apparatus 20 determines a position of a product 50 and/or a product sample in a product display region by processing an image generated by the image capturing apparatus 10. A person using the product identification apparatus 20 confirms whether a position of the product 50 and/or the product sample is a desired position by using a processing result of the product identification apparatus 20.

The image capturing apparatus 10 is a portable apparatus. The image capturing apparatus 10 may be a communication apparatus with an image capturing function, such as a smartphone. A user of the image capturing apparatus 10 generates an image by capturing an image of the product shelf 40, and transmits the image to an external apparatus, for example, the product identification apparatus 20. Further, by processing the image generated by the image capturing apparatus 10, the product identification apparatus 20 determines a position of the product 50 and/or the product sample.

It is often a case that a light source is disposed near the product shelf 40. As for a vending machine, a light-transmissive cover member is disposed in front of a product display region where a product and/or a product sample is disposed, and external light may be reflected on the cover member. Therefore, a part of an image may be overexposed, or conversely, an image may become unclear due to underexposure depending on an imaging condition. In view of the above, in the present example embodiment, the image capturing apparatus 10 generates a plurality of images by capturing a product display region a plurality of times while changing an imaging parameter. Further, the product identification apparatus 20 determines the product and/or the product sample located in the product display region by processing these plurality of images, and outputs a result of the determination.

Hereinafter, description is made based on a premise that a product placement region is the product shelf 40, and a product and/or a product sample is the product 50 placed on the product shelf 40.

Note that, one example of an imaging parameter is an exposure. As an example of a parameter for setting an exposure, at least one of an exposure time and an aperture is available.

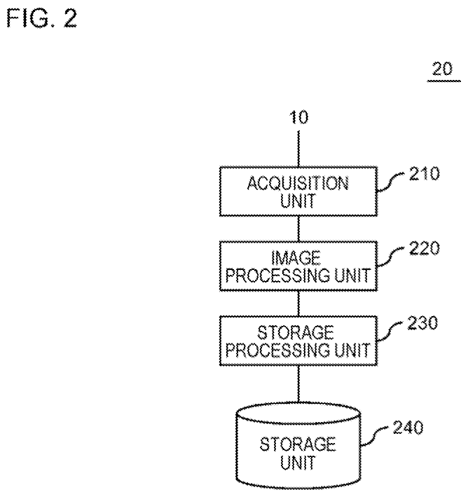

FIG. 2 is a diagram illustrating one example of a functional configuration of the product identification apparatus 20. In the example illustrated in FIG. 2, the product identification apparatus 20 includes an acquisition unit 210 and an image processing unit 220. The acquisition unit 210 acquires a plurality of images captured by the image capturing apparatus 10. The plurality of images are generated by capturing an image of the same product shelf 40 while changing a parameter. The image processing unit 220 determines the product 50 located on the product shelf 40 by processing the plurality of images, and outputs a result of the determination. The determination result is, for example, the one in which product identification information (e.g., a JAN code) of the product 50, and a position of the product 50 on the product shelf 40 are associated with each other. Note that, details on processing to be performed by the image processing unit 220 will be described later by using a flowchart.

In the present example embodiment, the product identification apparatus 20 includes a storage processing unit 230. The storage processing unit 230 is an output destination of a determination result of the image processing unit 220, and the determination result is stored in a storage unit 240. The storage unit 240 may be a part of the product identification apparatus 20, or may be an external storage apparatus of the product identification apparatus 20.

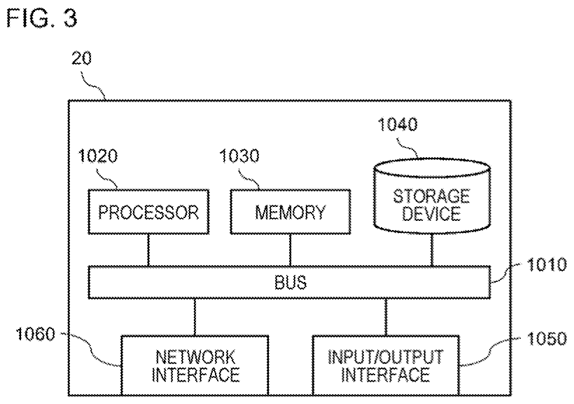

FIG. 3 is a diagram illustrating a hardware configuration example of the product identification apparatus 20. The product identification apparatus 20 includes a bus 1010, a processor 1020, a memory 1030, a storage device 1040, an input/output interface 1050, and a network interface 1060.

The bus 1010 is a data transmission path along which the processor 1020, the memory 1030, the storage device 1040, the input/output interface 1050, and the network interface 1060 mutually transmit and receive data. However, a method of mutually connecting to the processor 1020 and the like is not limited to bus connection.

The processor 1020 is a processor to be achieved by a central processing unit (CPU), a graphics processing unit (GPU), or the like.

The memory 1030 is a main storage to be achieved by a random access memory (RAM) or the like.

The storage device 1040 is an auxiliary storage to be achieved by a hard disk drive (HDD), a solid state drive (SSD), a memory card, a read only memory

(ROM), or the like. The storage device 1040 stores a program module achieving each function (e.g., the acquisition unit 210, the image processing unit 220, and the storage processing unit 230) of the product identification apparatus 20. The processor 1020 achieves each function associated with the program module by reading each program module in the memory 1030 and executing each program module. Further, the storage device 1040 also functions as the storage unit 240.

The input/output interface 1050 is an interface for connecting the product identification apparatus 20 and various pieces of input/output equipment with each other.

The network interface 1060 is an interface for connecting the product identification apparatus 20 to a network. The network is, for example, a local area network (LAN) or a wide area network (WAN). A method of connecting the network interface 1060 to a network may be wireless connection, or may be wired connection. The product identification apparatus 20 may communicate with the image capturing apparatus 10 via the network interface 1060.

Note that, a hardware configuration of the image capturing apparatus 10 is also similar to the example illustrated in FIG. 3.

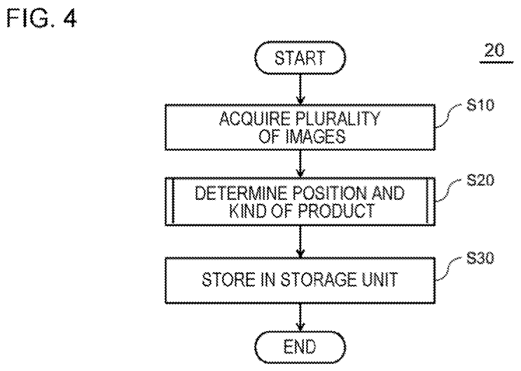

FIG. 4 is a flowchart illustrating a first example of processing to be performed by the product identification apparatus 20 In the example illustrated in FIG. 4, the image capturing apparatus 10 captures an image of the product shelf 40 a plurality of times while changing a parameter. Herein, in a case where an image of the product shelf 40 is captured by dividing the product shelf 40 into a plurality of regions, the image capturing apparatus 10 captures an image a plurality of times while changing a parameter, for each region. Further, the image capturing apparatus 10 may perform image capturing according to a program installed in the image capturing apparatus 10, or may perform image capturing according to an input from a user.

Then, the acquisition unit 210 of the product identification apparatus 20 acquires a plurality of images generated by the image capturing apparatus 10 (step S 10). Herein, the acquisition unit 210 may acquire a plurality of images from the image capturing apparatus 10 via a communication line, or may acquire the plurality of images from a storage apparatus that stores the plurality of images. In the latter case, a timing at which the product identification apparatus 20 performs processing may be or may not be immediately after the image capturing apparatus 10 generates a plurality of images.

Subsequently, the image processing unit 220 of the product identification apparatus 20 determines a position and a kind of the product 50 placed on the product shelf 40 by processing the plurality of images (step S20). Then, the storage processing unit 230 causes the storage unit 240 to store information indicating a determination result by the image processing unit 220 (step S30).

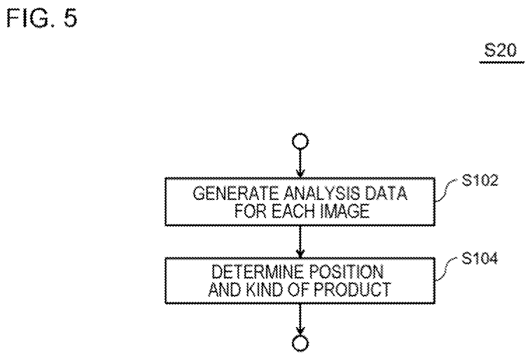

FIG. 5 is a flowchart illustrating a first detailed example of step S20 in FIG. 4. First, the image processing unit 220 recognizes a position and a kind of the product 50 for each image by individually processing each of the plurality of images (step S 102). Specifically, the image processing unit 220 determines a feature point of a product, and a position of the feature point for each image. Then, the image processing unit 220 recognizes a position and a kind of the product 50 for each image by performing matching processing of the feature point. In the matching processing, the image processing unit 220 uses data in which a feature point and product identification information are associated with each other. Then, the image processing unit 220 determines a position and a kind of the product 50 placed on the product shelf 40 by using these plurality of recognition results (step S104).

As one example, the image processing unit 220 tallies a plurality of recognition results, and uses a result of the tallying. Specifically, the image processing unit 220 tallies a kind of the product 50, for each position of the product 50, and determines that a kind in which the N number is largest, as a kind of the product 50 at the position. Herein, in a case where a plurality of recognition results are compared, a slight difference may occur at a position of the same product 50, but the position is handled as the same position by allowing the difference when tallying is performed.

Herein, regarding a product 50 whose presence is detected only in one recognition result, the image processing unit 220 determines that a kind indicated by the recognition result is a kind of the product 50. However, the image processing unit 220 may regard that only a product 50 whose presence is detected in a recognition result of a predetermined number or more (however, the predetermined number is an integer of two or more) is placed on the product shelf 40.

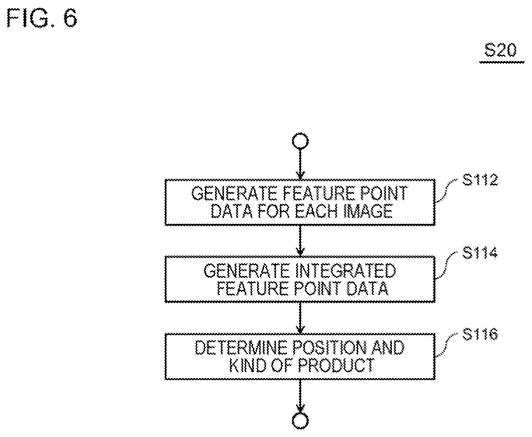

FIG. 6 is a flowchart illustrating a second detailed example of step S20 in FIG. 4. First, the image processing unit 220 generates feature point data of the product 50, for each image. The feature point data indicate a feature point of the product 50, and a position of the feature point (step S112). Subsequently, the image processing unit 220 integrates a plurality of pieces of feature point data generated in step S112 into one piece of integrated feature point data (step S114). Specifically, each of a plurality of pieces of feature point data has at least one set of combination of a feature point, and a position of the feature point. A piece of integrated feature point data is the one in which the above-described combination included in a plurality of pieces of feature point data is integrated as one piece of data.

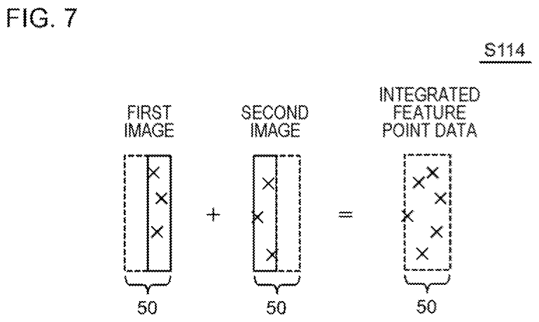

For example, as illustrated in FIG. 7, there is a case that only a right-side feature point of the product 50 is determined from a first image, and only a left-side feature point of the same product 50 is determined from a second image. Integrated feature point data include both of a feature point of a piece of first image data, and a feature point of a piece of second image data. Therefore, the integrated feature point data include feature points of the entirety of the product 50.

Then, the image processing unit 220 determines a position and a kind of the product 50 by performing feature point matching with respect to the integrated feature point data (step S116).

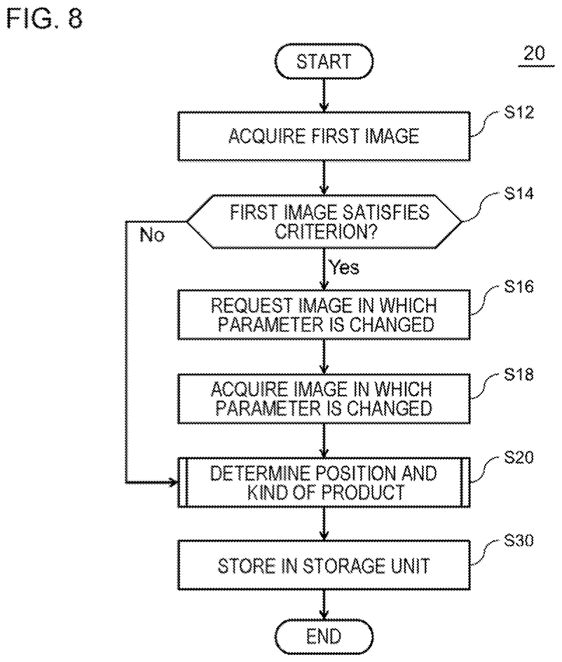

FIG. 8 is a flowchart illustrating a second example of processing to be performed by the product identification apparatus 20. In the example illustrated in FIG. 8, when a specific condition is satisfied, the product identification apparatus 20 requests the image capturing apparatus 10 for a plurality of images whose imaging parameters are different from each other.

As one example, first, the image capturing apparatus 10 generates one captured image (hereinafter, described as a first image) of a product shelf 40. The acquisition unit 210 of the product identification apparatus 20 acquires the first image (step S12). Herein, preferably, the acquisition unit 210 may acquire the first image from the image capturing apparatus 10 via a communication line immediately after the image capturing apparatus 10 generates the first image (specifically, before the image capturing apparatus 10 generates a next image).

Then, the image processing unit 220 determines whether the first image satisfies a criterion for image re-capturing (step S14). A first example of a criterion to be used herein is a case where overexposure occurs in at least a part of the first image (e.g., a case where a region in which all values of a red pixel, a green pixel, and a blue pixel become a reference value or more is present by a predetermined area or more). Further, a second example of the criterion is a case where exposure of the first image is insufficient (e.g., a case where values of all pixels are equal to or less than the reference value).

In a case where the first image does not satisfy a criterion for image re-capturing (step S14: No), the image processing unit 220 determines a kind and a position of the product 50 on the product shelf 40 by processing the first image (step S20). Then, the storage processing unit 230 causes the storage processing unit 230 to store a determination result by the image processing unit 220 (step S30).

On the other hand, in a case where the first image satisfies the criterion for image re-capturing (step S14: Yes), the image processing unit 220 performs processing of requesting the image capturing apparatus 10 for another image whose imaging parameter is different from that of the first image (step S16). When receiving a signal indicating the request, the image capturing apparatus 10 displays the receipt. A user of the image capturing apparatus 10 generates an image by changing the imaging parameter from the first image, and re-capturing an image of the product shelf 40. Herein, preferably, the image capturing apparatus 10 may generate a plurality of images while changing the imaging parameter. Then, the image capturing apparatus 10 transmits the generated image to the product identification apparatus 20. The acquisition unit 210 of the product identification apparatus 20 acquires the image (step S18). Then, the image processing unit 220 of the product identification apparatus 20 determines a kind and a position of the product 50 on the product shelf 40 by performing the processing illustrated in FIG. 5 or FIG. 6 (step S20). Then, the storage processing unit 230 causes the storage processing unit 230 to store a determination result by the image processing unit 220 (step S30).

As described above, according to the present example embodiment, the image capturing apparatus 10 captures an image of the product shelf 40 a plurality of times while changing an imaging parameter, and generates a plurality of images. Further, the product identification apparatus 20 determines a position and a kind of the product 50 placed on the product shelf 40 by processing these plurality of images. Therefore, recognition accuracy of the product 50 by image analysis is not lowered.

### Modification Example

In a present modification example, a part of processing to be performed by the image processing unit 220 of the product identification apparatus 20 is performed by the image capturing apparatus 10.

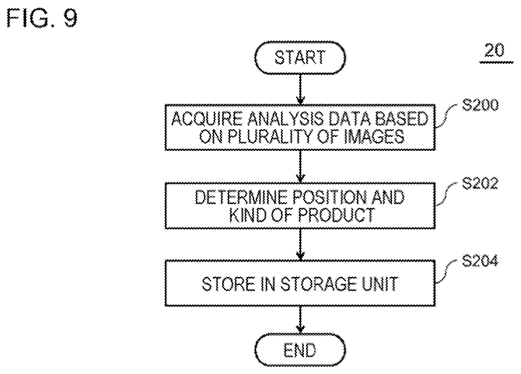

FIG. 9 is a flowchart illustrating processing to be performed by the product identification apparatus 20 according to a first modification example. The example illustrated in FIG. 9 is associated with the processing illustrated in FIG. 5. Specifically, the image capturing apparatus 10 generates data indicating a feature point of the product 50, and a position of the feature point, for each of a plurality of images.

Further, the image capturing apparatus 10 transmits, to the product identification apparatus 20, analysis data indicating the data, for each of the plurality of images. The acquisition unit 210 of the product identification apparatus 20 acquires the analysis data (step S200). Subsequently, the image processing unit 220 of the product identification apparatus 20 determines a position and a kind of the product 50 placed on the product shelf 40 by performing the processing illustrated in FIG. 5 or FIG. 6 (step S202). Then, the storage processing unit 230 causes the storage unit 240 to store a determination result by the image processing unit 220 (step S204). Also according to the present modification example, recognition accuracy of the product 50 by image analysis is not lowered similarly to the example embodiment.

As described above, while the example embodiment according to the present invention has been described with reference to the drawings, the example embodiment is an example of the present invention, and various configurations other than the above can also be adopted.

Further, in a plurality of flowcharts used in the above description, a plurality of processes (pieces of processing) are described in order, but an order of execution of processes to be executed in each example embodiment is not limited to the order of description. In each example embodiment, the illustrated order of processes can be changed within a range that does not adversely affect a content. Further, the above-described example embodiments can be combined, as far as contents do not conflict with each other.

A part or all of the above-described example embodiments may also be described as the following supplementary notes, but is not limited to the following.

1. A product identification apparatus including:
an acquisition unit that acquires a plurality of images obtained by capturing a product display region where a product and/or a product sample is arranged, the plurality of images having different imaging parameters of an image capturing unit from each other; and
an image processing unit that determines the product and/or the product sample located in the product display region by processing the plurality of images, and outputs a result of the determination.
   2. The product identification apparatus according to supplementary note 1, wherein
the image processing unit recognizes a position of a product or a product sample, and a kind of the product or the product sample, for each of the plurality of images, and determines the product or the product sample located in the product display region by using a recognition result of each image.
   3. The product identification apparatus according to supplementary note 1, wherein
the image processing unit
   generates feature point data indicating a feature point of a product or a product sample and a position of the feature point, for each of the plurality of images, and
   integrates the plurality of pieces of the feature point data, as one piece of integrated feature point data, and determines the product or the product sample located in the product display region by using the integrated feature point data.
      4. The product identification apparatus according to any one of supplementary notes 1 to 3, wherein
the parameter is an exposure.
   5. The product identification apparatus according to any one of supplementary notes 1 to 4, wherein
the acquisition unit requests the image capturing unit for the plurality of images, when a specific condition is satisfied.
   6. The product identification apparatus according to supplementary note 5, wherein
the acquisition unit
   acquires a first image from the image capturing unit, and,
   in a case where the first image satisfies a criterion, assumes that the specific condition is satisfied and requests the image capturing unit for another image whose parameter is different from that of the first image, and
the image processing unit, in a case where the first image does not satisfy the criterion, determines the product or the product sample located in the product display region by processing the first image.
   7. A product identification apparatus including:
an acquisition unit that acquires analysis data being a result of processing a plurality of images obtained by capturing a product display region where a product and/or a product sample is arranged, and indicating a feature point of a product or a product sample and a position of the feature point, for each of the plurality of images; and
a data processing unit that determines the product or the product sample located in the product display region by processing the analysis data, and outputting a result of the determination, wherein
the plurality of images have different imaging parameters of an image capturing unit from each other.
   8. A product identification method including,
by a computer:
acquisition processing of acquiring a plurality of images obtained by capturing a product display region where a product and/or a product sample is arranged, the plurality of images having different imaging parameters of an image capturing unit from each other; and
image processing of determining the product or the product sample located in the product display region by processing the plurality of images, and outputting a result of the determination.
   9. The product identification method according to supplementary note 8, further including,
by the computer,
in the image processing, recognizing a position of a product or a product sample, and a kind of the product or the product sample, for each of the plurality of images, and determining the product or the product sample located in the product display region by using a recognition result of each image.
   10. The product identification method according to supplementary note 8, further including,
by the computer:
in the image processing,
   generating feature point data indicating a feature point of a product or a product sample and a position of the feature point, for each of the plurality of images; and
   integrating the plurality of pieces of the feature point data, as one piece of integrated feature point data, and determining the product or the product sample located in the product display region by using the integrated feature point data.
      11. The product identification method according to any one of supplementary notes 8 to 10, wherein
the parameter is an exposure.
   12. The product identification method according to any one of supplementary notes 8 to 11, further including,
by the computer,
in the acquisition, requesting the image capturing unit for the plurality of images, when a specific condition is satisfied.
   13. The product identification method according to supplementary note 12, further including,
by the computer:
in the acquisition,
   acquiring a first image from the image capturing unit;
   in a case where the first image satisfies a criterion, assuming that the specific condition is satisfied, and requesting the image capturing unit for another image whose parameter is different from that of the first image,; and,
in the image processing, in a case where the first image does not satisfy the criterion, determining the product or the product sample located in the product display region by processing the first image.
   13. A product identification method including,
by a computer:
acquiring analysis data being a result of processing a plurality of images obtained by capturing a product display region where a product and/or a product sample is arranged, and indicating a feature point of a product or a product sample and a position of the feature point, for each of the plurality of images; and
determining the product or the product sample located in the product display region by processing the analysis data, and outputting a result of the determination, wherein
the plurality of images have different imaging parameters of an image capturing unit from each other.
   14. A program causing a computer to include:
an acquisition function of acquiring a plurality of images obtained by capturing a product display region where a product and/or a product sample is arranged, the plurality of images having different imaging parameters of an image capturing unit from each other; and
an image processing function of determining the product or the product sample located in the product display region by processing the plurality of images, and outputting a result of the determination.
   15. The program according to supplementary note 14, wherein
the image processing function recognizes a position of a product or a product sample, and a kind of the product or the product sample, for each of the plurality of images, and determines the product or the product sample located in the product display region by using a recognition result of each image.
   16. The program according to supplementary note 14, wherein
the image processing function
   generates feature point data indicating a feature point of a product or a product sample and a position of the feature point, for each of the plurality of images, and
   integrates the plurality of pieces of the feature point data, as one piece of integrated feature point data, and determines the product or the product sample located in the product display region by using the integrated feature point data.
      17. The program according to any one of supplementary notes 14 to 16, wherein
the parameter is an exposure.
   18. The program according to any one of supplementary notes 14 to 17, wherein
the acquisition function requests the image capturing unit for the plurality of images, when a specific condition is satisfied.
   19. The program according to supplementary note 18, wherein
the acquisition function
   acquires a first image from the image capturing unit, and,
   in a case where the first image satisfies a criterion, assumes that the specific condition is satisfied and requests the image capturing unit for another image whose parameter is different from that of the first image, and
the image processing function, in a case where the first image does not satisfy the criterion, determines the product or the product sample located in the product display region by processing the first image.
   20. A program causing a computer to include:
an acquisition function of acquiring analysis data being a result of processing a plurality of images obtained by capturing a product display region where a product and/or a product sample is arranged, and indicating a feature point of a product or a product sample and a position of the feature point, for each of the plurality of images; and
a data processing function of determining the product or the product sample located in the product display region by processing the analysis data, and outputting a result of the determination, wherein
the plurality of images have different imaging parameters of an image capturing unit from each other.

### REFERENCE SIGNS LIST

10 Image capturing apparatus
20 Product identification apparatus
40 Product shelf
50 Product
210 Acquisition unit
220 Image processing unit
230 Storage processing unit
240 Storage unit

What is claimed is:

1. A product identification apparatus comprising:
at least one memory configured to store instructions; and
at least one processor configured to execute the instructions to perform operations comprising: and
acquiring a plurality of images obtained by capturing a product display region where a product and/or a product sample is arranged, the plurality of images having different imaging parameters of a camera from each other; and
determining the product and/or the product sample located in the product display region by processing the plurality of images, and outputting a result of the determination.

2. The product identification apparatus according to claim 1, wherein
the operations comprise recognizing a position of a product or a product sample, and a kind of the product or the product sample, for each of the plurality of images, and determining the product or the product sample located in the product display region by using a recognition result of each image.

3. The product identification apparatus according to claim 1, wherein
the operations comprise
generating feature point data indicating a feature point of a product or a product sample and a position of the feature point, for each of the plurality of images, and
integrating the plurality of pieces of the feature point data, as one piece of integrated feature point data, and determines determining the product or the product sample located in the product display region by using the integrated feature point data.

4. The product identification apparatus according to claim 1, wherein
the parameter is an exposure.

5. The product identification apparatus according to claim 1, wherein
the operations comprise requesting the camera for the plurality of images, when a specific condition is satisfied.

6. The product identification apparatus according to claim 5, wherein
the operations comprise
acquiring a first image from the camera, and,
in a case where the first image satisfies a criterion, assuming that the specific condition is satisfied and requesting the camera for another image whose parameter is different from that of the first image, and
in a case where the first image does not satisfy the criterion, determines the product or the product sample located in the product display region by processing the first image.

7. (canceled)

8. A product identification method comprising,
by a computer:
acquiring a plurality of images obtained by capturing a product display region where a product and/or a product sample is arranged, the plurality of images having different imaging parameters of a camera from each other; and
determining the product or the product sample located in the product display region by processing the plurality of images, and outputting a result of the determination.

9. (canceled)

10. A non-transitory computer-readable medium storing a program causing a computer to perform operations comprising:
acquiring a plurality of images obtained by capturing a product display region where a product and/or a product sample is arranged, the plurality of images having different imaging parameters of an imagc capturing unit a camera from each other; and
determining the product or the product sample located in the product display region by processing the plurality of images, and outputting a result of the determination.

11. (canceled)
